(19) United States
(12) Patent Application Publication
(10) Pub. No.: US 2026/0034445 A1
(43) Pub. Date: Feb. 5, 2026

(54) METHOD AND APPARATUS FOR CONTROLLING VIRTUAL CHARACTER, AND TERMINAL AND STORAGE MEDIUM

(71) Applicant: TENCENT TECHNOLOGY (SHENZHEN) COMPANY LIMITED, Shenzhen (CN)

(72) Inventor: Xiaoquan HUANG, Shenzhen (CN)

(21) Appl. No.: 19/356,701

(22) Filed: Oct. 13, 2025

Related U.S. Application Data
(63) Continuation of application No. PCT/CN2024/105344, filed on Jul. 12, 2024.

(30) Foreign Application Priority Data
Sep. 12, 2023 (CN) 202311176458.8

(51) Int. Cl. A63F 13/52; A63F 13/533; A63F 13/60

(52) U.S. Cl. CPC A63F 13/52; A63F 13/533; A63F 13/60

(57) ABSTRACT

A virtual character control method performed by a computer device includes displaying a virtual environment picture of a virtual environment observed from an angle of view of a first virtual character, and displaying prompt information in response to a character state of the first virtual character meeting a preset condition. The prompt information indicates that the first virtual character has a capability of carrying another virtual character. The method further includes canceling display of a second virtual character in response to the second virtual character being within a preset range of the first virtual character. A position of the second virtual character, whose display is canceled, changes along with a position of the first virtual character.

### CROSS-REFERENCE TO RELATED APPLICATIONS

This application is a continuation of International Application No. PCT/CN2024/105344, filed on Jul. 12, 2024, which claims priority to Chinese Patent Application No. 202311176458.8, filed on Sep. 12, 2023 and entitled “METHOD AND APPARATUS FOR CONTROLLING VIRTUAL CHARACTER, AND TERMINAL AND STORAGE MEDIUM,” the entire contents of both of which are incorporated herein by reference.

### FIELD OF THE TECHNOLOGY

Embodiments of this application relate to the field of computer technologies, and in particular, to a method and apparatus for controlling a virtual character, a device, and a storage medium.

### BACKGROUND OF THE DISCLOSURE

Currently, some game application programs (for example, shooting game application programs) are provided with virtual vehicles, such as a virtual car, a virtual yacht, a virtual plane, and a virtual horse. A virtual character controlled by a user may drive a virtual vehicle to carry another virtual character.

However, the user needs to first find a virtual vehicle and drive the virtual vehicle to a location near another virtual character, and then can carry the other virtual character to move. The operations are not convenient.

### SUMMARY

In accordance with the disclosure, there is provided a virtual character control method performed by a computer device and including displaying a virtual environment picture of a virtual environment observed from an angle of view of a first virtual character, and displaying prompt information in response to a character state of the first virtual character meeting a preset condition. The prompt information indicates that the first virtual character has a capability of carrying another virtual character. The method further includes canceling display of a second virtual character in response to the second virtual character being within a preset range of the first virtual character. A position of the second virtual character, whose display is canceled, changes along with a position of the first virtual character.

Also in accordance with the disclosure, there is provided a terminal device including a processor, and a memory storing a computer program that, when executed by the processor, causes the terminal device to display a virtual environment picture of a virtual environment observed from an angle of view of a first virtual character, and display prompt information in response to a character state of the first virtual character meeting a preset condition. The prompt information indicates that the first virtual character has a capability of carrying another virtual character. The computer program further causes the terminal device to cancel display of a second virtual character in response to the second virtual character being within a preset range of the first virtual character. A position of the second virtual character, whose display is canceled, changes along with a position of the first virtual character.

Also in accordance with the disclosure, there is provided a virtual character control method performed by a computer device and including displaying a virtual environment picture of a virtual environment and, in response to prompt information, that indicates a first virtual character having a capability of carrying another virtual character, being displayed and a second virtual character moving into a preset range of the first virtual character, updating display of the virtual environment picture. The virtual environment picture is a picture of the virtual environment observed from an angle of view of the second virtual character. Display of the second virtual character in the virtual environment is canceled and a position of the second virtual character in the virtual environment changes along with a position of the first virtual character.

### BRIEF DESCRIPTION OF THE DRAWINGS

FIG. 1 is a schematic diagram of a control system according to an embodiment of this application.

FIG. 2 is a flowchart of a method for controlling a virtual character according to an embodiment of this application.

FIG. 3 is a schematic diagram showing a first virtual environment picture according to an embodiment of this application.

FIG. 4 is a schematic diagram showing prompt information according to an embodiment of this application.

FIG. 5 is a schematic diagram showing a second virtual character moving into a shadow of a first virtual character according to an embodiment of this application.

FIG. 6 is a schematic diagram showing a first virtual character carrying a second virtual character according to an embodiment of this application.

FIG. 7 is a flowchart of a method for controlling a virtual character according to another embodiment of this application.

FIG. 8 is a schematic diagram showing a second virtual environment picture according to an embodiment of this application.

FIG. 9 is a schematic diagram showing a second control according to an embodiment of this application.

FIG. 10 is a schematic diagram showing a second virtual environment picture according to another embodiment of this application.

FIG. 11 is a flowchart of a method for controlling a virtual character according to another embodiment of this application.

FIG. 12 is a block diagram of an apparatus for controlling a virtual character according to an embodiment of this application.

FIG. 13 is a block diagram of an apparatus for controlling a virtual character according to another embodiment of this application.

FIG. 14 is a block diagram of a terminal device according to an embodiment of this application.

### DESCRIPTION OF EMBODIMENTS

To make the objectives, technical solutions, and advantages of this application clearer, the following further describes implementations of this application in detail with reference to the accompanying drawings.

Before embodiments of this application are described, relevant terms in this application are first defined and described.

### 1. Virtual Environment

A virtual environment is an environment displayed (or provided) when a client of an application program (for example, a game application program) runs on a terminal device. The virtual environment refers to an environment created for a virtual object to perform activities (for example, a game competition), such as a virtual house, a virtual island, or a virtual map. The virtual environment may be a simulated environment of the real world, or may be a semi-simulated and semi-fictional environment, or may be a completely fictional environment. The virtual environment may be a three-dimensional virtual environment, or may be a 2.5-dimensional virtual environment, or may be a two-dimensional virtual environment. This is not limited in the embodiments of this application. The foregoing virtual object may include a virtual character, a virtual vehicle, a virtual animal, or the like.

### 2. Virtual Character

A virtual character is a character controlled by a user account in an application program. For example, an application program is a game application program. The virtual character refers to a game character controlled by a user account in the game application program. The virtual character may be in a human form, an animal form, a cartoon form, or another form. This is not limited in the embodiments of this application. The virtual character may be displayed in a three-dimensional form or a two-dimensional form. This is not limited in the embodiments of this application. The virtual character in the embodiments of this application is different from the virtual vehicle. That is, the foregoing virtual character does not have a capability of carrying another virtual character.

In different game application programs, operations that can be performed by virtual characters controlled by user accounts may be different. For example, in a shooting game application program, a user account may control a virtual character to perform operations such as shooting, moving, running, jumping, casting skills, and using a virtual prop. The game application program may be any one of a multiplayer online battle arena (MOBA) game, a first-person shooting game (FPS), a multiplayer gunfight survival game, a third-person shooting (TPS) game, a simulation game (SLG), and the like.

Of course, in addition to the game application programs, other types of application programs may also present a virtual character to a user, and provide a corresponding function for the virtual character. For example, an augmented reality (AR) application program, a virtual reality (VR) application program, a mixed reality (MR) application program, a social application program, an interactive entertainment application program, and the like. This is not limited in the embodiments of this application. In addition, for different application programs, forms of virtual characters provided by them may also be different, and corresponding functions may also be different. These may be configured in advance according to actual requirements. This is not limited in the embodiments of this application.

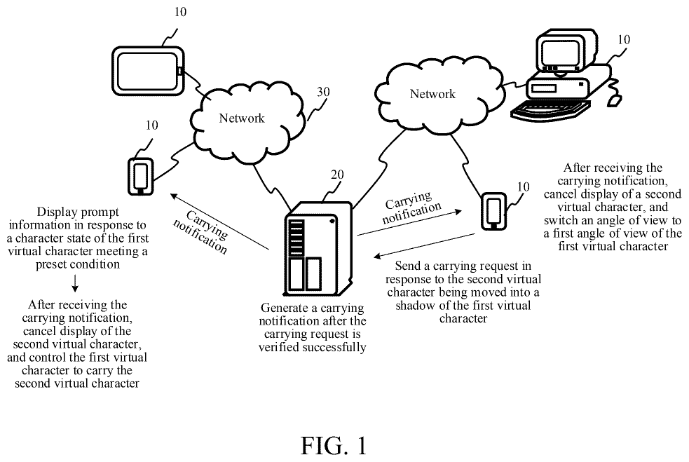

Referring to FIG. 1, a schematic diagram of a control system according to an embodiment of this application is shown. The control system may include: a terminal device 10 and a server 20.

The terminal device 10 may be an electronic device, such as a mobile phone, a tablet computer, a multimedia playing device, a personal computer (PC), an intelligent robot, a vehicle-mounted terminal, a wearable device, an AR device, a VR device, and an MR device. A client of an application program may be installed in the terminal device 10. The application program may be, for example, a game application program, a social entertainment application program, or a simulation learning application program.

The application program may be an online application program. For example, the client of the application program may be installed and run in different terminal devices 10, for use by different users. By taking a game application program as an example, the game application program may be installed and run in different terminal devices 10 in a form of a mobile game, a personal computer (PC) game, a webpage, an applet, or the like. This is not limited in the embodiments of this application. The application program may also be a plug-and-play application program. This is not limited in the embodiments of this application.

The server 20 is configured to provide a background service for the client of the application program (for example, a game application program) in the terminal device 10. For example, the server 20 may be a background server of the foregoing application program (for example, a game application program). The server 20 may be one server, or may be a server cluster including a plurality of servers, or a cloud computing service center.

The terminal device 10 may communicate with the server 20 through a network 30. The network 30 may be a wired network, or may be a wireless network.

For example, by taking a game application program as an example, in a game battle, a first virtual character may have a capability of carrying another virtual character by using a first virtual prop. Moreover, the client displays prompt information on a shadow of the first virtual character to prompt other virtual characters that the first virtual character has the capability of carrying another virtual character at this time. Taking a preset range as the shadow of the first virtual character as an example, when a second virtual character moves into the shadow of the first virtual character, the client corresponding to the second virtual character transmits a carrying request to the server, and after successfully verifying the carrying request, the server sends a carrying notification to the client corresponding to the first virtual character and the client corresponding to the second virtual character, respectively. After receiving the carrying notification, the client corresponding to the first virtual character cancels the display of the second virtual character, and controls the first virtual character to carry the second virtual character. After receiving the carrying notification, the client corresponding to the second virtual character also cancels the display of the second virtual character, and switches an angle of view to a first angle of view of the first virtual character, so as to display a virtual environment picture at the first angle of view.

The technical solutions provided in this application will be described below through the method embodiments.

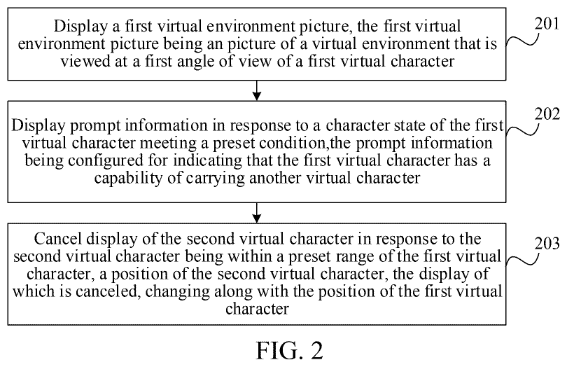

Referring to FIG. 2, a flowchart of a method for controlling a virtual character according to an embodiment of this application is shown. An execution entity of operations of the method may be the terminal device 10 in the control system shown in FIG. 1, for example, the client in the terminal device 10. The method may include the following operations (201-203).

Operation 201: Display a first virtual environment picture, the first virtual environment picture being a picture of a virtual environment that is observed from a first angle of view of a first virtual character.

The virtual environment is an environment displayed (or provided) when a client of an application program (for example, a game application program) runs on the terminal device. The virtual environment may be used for a virtual object to perform activities. The virtual object in the embodiments of this application may be an object capable of performing activities in the virtual environment, for example, a virtual character, a virtual vehicle, or a virtual animal. The foregoing virtual environment picture is a picture obtained by observing the virtual environment. For example, the first virtual environment picture is a virtual environment picture obtained through observing the virtual environment by the first virtual character. The foregoing virtual character may be a character controlled by a user account in the application program. For example, the first virtual character may be a virtual character controlled by a currently logged-in user account in the terminal device.

The foregoing first angle of view is an angle of view of the first virtual character, and may be set and adjusted according to an actual use requirement. For example, the first angle of view may be a first-person angle of view, a third-person angle of view, or the like that is based on the first virtual character. This is not limited in the embodiments of this application.

In an example, the virtual environment is an environment provided by the game battle, and a plurality of virtual characters compete in the virtual environment. In some embodiments, the game battle includes at least two factions, virtual characters belonging to different factions may be in a cooperation relationship, an adversarial relationship, or the like, and multiple virtual characters belonging to the same faction may be in a teammate relationship. The virtual characters belonging to the different factions may attack each other, and the virtual characters belonging to the same faction may rescue each other. In some embodiments, the virtual environment may also be an environment provided by a game level, or the virtual environment may also be an environment provided by a game activity. This is not limited in the embodiments of this application.

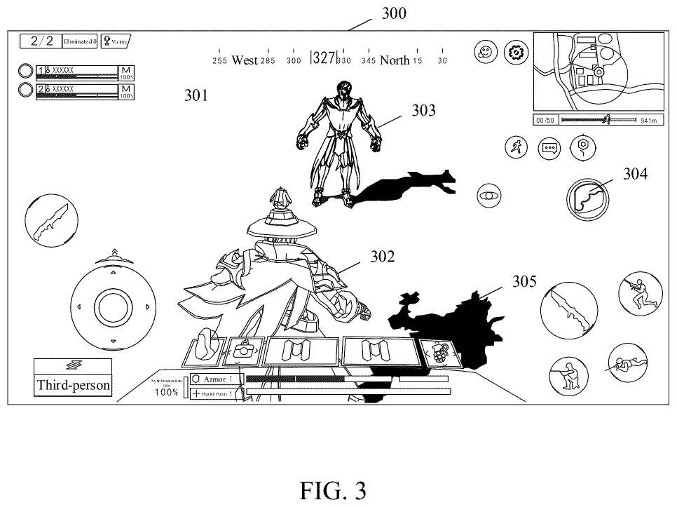

For example, referring to FIG. 3, after one game battle is started, the client displays a first virtual environment picture 301 on a user interface 300. The first virtual environment picture 301 is a picture of the virtual environment that is observed from a third-person angle of view of a first virtual character 302. The first virtual environment picture 301 includes a first virtual character 302 and a second virtual character 303 located in the virtual environment. The first virtual character 302 and the second virtual character 303 may be controlled by a user to perform activities, for example, releasing a skill, using a virtual prop, walking, or running, in the virtual environment. Unless otherwise specified, the client in the embodiments of this application refers to the client corresponding to the first virtual character.

Operation 202: Display prompt information in response to a character state of the first virtual character meeting a preset condition, the prompt information being configured for indicating that the first virtual character has a capability of carrying another virtual character.

The preset condition is a condition that is preset, and the character state is configured for characterizing a state in which the first virtual character participates in a virtual battle in the virtual environment.

In some embodiments, the character state includes an attribute state of the first virtual character, and whether the character state meets the preset condition is determined according to whether the attribute state of the first virtual character meets a preset state. The attribute state includes at least one of a plurality of character attributes such as a virtual health value, a virtual mana value, and a virtual character level. For example, when an object level of the first virtual character reaches 10, it is considered that the character state of the first virtual character meets the preset condition. Or, when the virtual health value of the first virtual character reaches 80%, it is considered that the character state of the first virtual character meets the preset condition.

In some embodiments, the character state includes a skill state of the first virtual character. Whether the character state meets the preset condition can be determined according to whether the skill state of a skill possessed by the first virtual character at a current moment matches an applicable state. The skill state includes at least one of a plurality of states such as a skill cooldown state (a current skill in a waiting state cannot be used), a skill available state (a current skill can be used), and a skill locking state (a current skill is locked and cannot be used). For example, when the first skill possessed by the first virtual character is in the skill available state, it is considered that the character state of the first virtual character meets the preset condition.

In some embodiments, the character state includes a state in which the first virtual character uses the virtual prop, and whether the character state of the first virtual character meets the preset condition may be determined by determining whether the first virtual character uses a preset virtual prop.

For example, when the first virtual character uses the first virtual prop, it is considered that the character state of the first virtual character meets the preset condition. Or, when the first virtual character uses the first virtual prop towards a preset direction, it is considered that the character state of the first virtual character meets the preset condition, and so on.

The foregoing situations in which the character state meets the preset condition are merely exemplary examples. This is not limited in the embodiments of this application.

In an exemplary embodiment, the following descriptions are provided by taking a situation in which the state of the first virtual character using the first virtual prop is considered as that the character state meets the preset condition as an example.

In some embodiments, the client displays a process in which the first virtual character uses the first virtual prop in response to an operation signal for the first virtual prop generated by the user by using the terminal device. After the first virtual prop is used, the client displays prompt information. The operation signal may be generated by the user through a touch screen on the terminal device. For example, the user may trigger (for example, tap, double tap, swipe, or long press) a prop use control on the user interface displayed on the touch screen, so as to generate the operation signal for the first virtual prop to implement use of the first virtual prop. Operation information may also be generated by the user via using an external device (for example, a mouse, a keyboard, a joystick, or a gamepad) of the terminal device, so as to implement the use of the first virtual prop. This is not limited in the embodiments of this application.

The virtual prop is a prop provided by an application program for use by a virtual character. The virtual prop may be a simulated prop for a real object (for example, a chip, a scroll, or a tool), may be a semi-simulated and semi-fictional prop, or may be a pure-fictional prop. This is not limited in the embodiments of this application. In some embodiments, the virtual prop may be obtained in the virtual environment, or may be assembled before the game battle is started. This is not limited in the embodiments of this application.

For example, the foregoing virtual prop may be a skill chip. Different skill chips correspond to different functions, for example, a co-movement function, a stealth function, an enhancement function, a flight function, and a confinement function. The co-movement function enables a user of the skill chip to have the capability of carrying another virtual character (hereinafter referred to as a co-movement capability). Before the game battle is started (for example, at a preparation stage), the user may select and assemble the skill chip. The virtual character in the embodiments of this application does not have the capability of carrying another virtual character (i.e. the co-movement capability).

In some embodiments, the first virtual prop in the embodiments of this application may be a skill chip having the co-movement function, which enables a prop trigger control, such as a prop trigger control 304 (in a button style) shown in FIG. 3, to be correspondingly displayed on the user interface. The user can trigger the prop trigger control 304 and then use the first virtual prop.

In some embodiments, in response to the operation of using the first virtual prop being received, the prompt information is displayed on the shadow of the first virtual character.

The shadow of the first virtual character is a relatively dark region in the virtual environment that is formed due to a virtual object blocks the propagation of virtual light and the virtual light cannot pass through an opaque object. In some embodiments, the shadow may be a shadow generated by simulation. For example, the shadow of the first virtual character may be a shadow generated while the first virtual character is illuminated by a virtual light source, such as a virtual sun, a virtual lamp, or virtual fire. For example, referring to FIG. 3, a shadow 305 is generated on a virtual ground while the first virtual character 302 is illuminated by the virtual light source, and a shape of the shadow 305 is related to a model shape of the first virtual character 302 and an angle between the first virtual character 302 and the virtual light source.

The prompt information in this application is visual content, such as text prompt information, image prompt information, animation prompt information, and special effect prompt information. For example, the client may display the text “Enter carry mode” on or above the shadow of the first virtual character, or may display the special effect “Wormhole” on or above the shadow of the first virtual character. This is not limited in the embodiments of this application. In some embodiments, the prompt information is associated with the co-movement capability. For example, during a display period of the prompt information, the first virtual character provides a carrying entry to another virtual character, and during a period in which the display of the prompt information is canceled, the first virtual character does not provide the carrying entry to another virtual character.

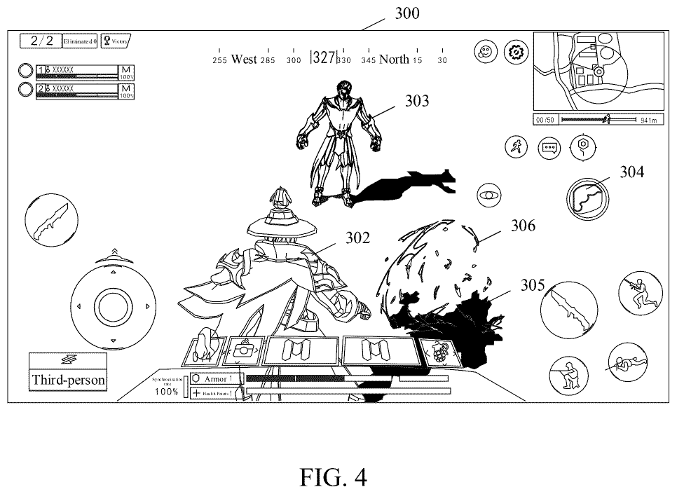

In an example, the prompt information is visible to a teammate virtual character located in a same virtual faction as the first virtual character (that is, the teammate virtual character can see the prompt information). For example, the second virtual character is a teammate virtual character, and the prompt information is visible to the second virtual character. However, the prompt information is invisible to enemy virtual characters located in different virtual factions from the first virtual character (that is, the enemy virtual characters cannot see the prompt information). For example, referring to FIG. 3 and FIG. 4, in response to the virtual prop control 304 being triggered, the client displays a special effect 306 (i.e. the prompt information) above the shadow 305 of the first virtual character 302. In a case that the second virtual character 303 is a teammate of the first virtual character 302, the special effect 306 is visible to the second virtual character 303.

In an example, the character state of the first virtual character reaching the preset state includes: the first virtual character uses the first virtual prop; and in response to receiving an operation of controlling the first virtual character to use the first virtual prop, the client displays the prompt information on the shadow of the first virtual character if the first virtual prop meets the trigger condition.

The trigger condition is configured for indicating whether the first virtual prop can be triggered, and the trigger condition may include at least one of the following.
1. An energy value of the first virtual prop reaches a maximum energy value. To be specific, if the energy value of the first virtual prop reaches the maximum energy value, the client displays the prompt information in response to the operation of using the first virtual prop. If the energy value of the first virtual prop does not reach the maximum energy value, the client skips displaying the prompt information in response to the operation of using the first virtual prop. For example, referring to FIG. 3, the virtual prop control 304 represents, in a form of a virtual energy gauge, whether the energy value reaches the maximum energy value. When energy in the virtual energy gauge is fully filled, the first virtual prop may become available. The energy value of the first virtual prop increases over time. In some embodiments, the user may also complete a task and defeat enemies to obtain the energy value. After the first virtual prop is used, the energy value of the first virtual prop is reset to 0.
2. A remaining cooldown duration of the first virtual prop is 0. To be specific, if the remaining cooldown duration of the first virtual prop is 0, the client displays the prompt information in response to the operation of using the first virtual prop. If the remaining cooldown duration of the first virtual prop is not 0, the client skips displaying the prompt information in response to the operation of using the first virtual prop.
3. The first virtual character has a shadow. To be specific, if the first virtual character has a shadow, the client displays the prompt information in response to the operation of using the first virtual prop. If the first virtual character has no shadow, the client skips displaying the prompt information in response to the operation of using the first virtual prop.

In an example, the operation of the first virtual character using the first virtual prop is considered as that the character state of the first virtual character meets the preset condition. In response to receiving the operation of controlling the first virtual character to use the first virtual prop, the client obtains a shadow area corresponding to the shadow of the first virtual character if the first virtual prop meets the trigger condition, and displays the prompt information on the shadow of the first virtual character in a case that the shadow area is greater than or equal to a first threshold.

Description of the trigger condition in this embodiment of this application is the same as the description in the foregoing embodiments. Details are not described herein again. The shadow area is configured for indicating a size of the shadow, for example, an area occupied by the shadow on the virtual ground. The foregoing first threshold may be set and adjusted according to an actual use requirement. This is not limited in the embodiments of this application. For example, the foregoing first threshold may be ½, ⅓, ¼, or the like of a maximum shadow area.

The foregoing content describes a process of displaying the prompt information on the shadow. If the operation of the first virtual character using the first virtual prop is considered as that the character state of the first virtual character meets the preset condition, the prompt information may be displayed on the shadow when the first prop meets the trigger condition, or the prompt information may be displayed on the shadow when the first prop meets the trigger condition and the shadow area reaches the first threshold. By introducing comparison content such as the trigger condition and the first threshold, a relatively clear logical judgment mechanism is set for displaying the prompt information, facilitating the improvement of controllability and adaptability of a prompt information displaying process, avoiding the problem of improper display of the prompt information, and facilitating the improvement of human-machine interaction efficiency while enriching game gameplay.

In some embodiments, in a case that the shadow area is greater than or equal to the first threshold, the client does not display the prompt information if the first virtual character is in a first state, the first state including at least one of the following: a knocked-down state, being in a virtual vehicle, a climbing state, a rescue state, or a virtual health value being 0. The knocked-down state may be a state in which an attack capability is lost and the virtual health value changes to 0 after a threshold time. The rescue state may be a state of rescuing another virtual character. In some feasible embodiments, if the first virtual character is in the first state, the client directly switches the first virtual prop to a disabled state, and the first virtual prop in the disabled state cannot be used.

In some embodiments, in a case that the shadow area is less than the first threshold, the client also does not display the prompt information on the shadow of the first virtual character.

In the embodiments of this application, whether to display the prompt information is determined in combination with the trigger condition and the shadow area, so that the user needs to consider the trigger condition and the shadow area when using the first virtual prop, thereby improving the strategic depth and balance of using the first virtual prop. The foregoing content further describes that even if the shadow area reaches the first threshold, whether to display content of the prompt information further needs to be determined based on the state of the first virtual character. For example, when the first virtual character is in the first state that is inconvenient for carrying another virtual character, such as the knocked-down state or the virtual health value being 0, the prompt information is not displayed. By considering the first state, a running process of the virtual environment is more realistic, which avoids increasing a game burden of the first virtual character in a case that it is inconvenient for the first virtual character to carry the second virtual character, and improves the human-machine interaction efficiency while considering a game interaction effect. In addition, the first virtual prop cannot be triggered by limiting the first virtual character in some states, thereby improving the balance of using the first virtual prop.

In some embodiments, during the display period of the prompt information, another virtual character may trigger the first virtual character to carry, and after the display of the prompt information is canceled, another virtual character may be not able to trigger the first virtual character to carry.

In an example, the prompt information corresponds to a display duration. That is, after the prompt information reaches the display duration, the client cancels the display of the prompt information. The embodiments of this application may further include the following content: obtain a shadow area of the shadow when the first virtual prop is used; and determine a display duration of the prompt information according to the shadow area, the display duration of the prompt information being positively correlated with the shadow area.

The larger the shadow area when the first virtual prop is used, the longer the display duration of the prompt information, and the smaller the shadow area when the first virtual prop is used, the shorter the display duration of the prompt information. In some embodiments, the shadow area may be directly determined as the display duration of the prompt information, or a product of a factor, namely the area, and a specified parameter may be determined as the display duration of the prompt information, or the display duration corresponding to a duration level corresponding to an area level of the shadow area may be determined as the display duration of the prompt information. This is not limited in the embodiments of this application. In this way, the display duration of the prompt information is determined by using the shadow area, so that the strategic depth of using the first virtual prop may be further improved.

The foregoing content describes a process of determining the display duration of the prompt information according to the shadow area. The display duration of the prompt information is associated with the shadow area, so that the display of the prompt information is more consistent with a lighting change and an environment change in the virtual environment, thereby enhancing a sense of reality of a game. By means of the positive correlation between the shadow area and the display duration of the prompt information, the strategic depth of the game can also be enhanced, and the prompt information can be displayed more flexibly, thereby bringing more immersive game experience to players.

In an example, a method for determining the display duration of the prompt information may also include the following operations: obtaining a first ratio of a model area of the second virtual character to a model area of the first virtual character; and determining a display duration of the prompt information according to the first ratio and the shadow area, the display duration of the prompt information being positively correlated with the first ratio, and the display duration of the prompt information being positively correlated with the shadow area.

In some embodiments, the model area of the second virtual character is divided by the model area of the first virtual character to obtain the first ratio. The model area may be an area of a horizontal projection of the model, may be an area of a vertical projection of the model, or may be a volume of the model. This is not limited in the embodiments of this application.

In some embodiments, the display duration of the prompt information may be determined based on a product of the first ratio and the shadow area, or weighted summation may be performed on the first ratio and the shadow area to obtain the display duration of the prompt information. This is not limited in the embodiments of this application.

The foregoing content describes that when the shadow area is positively correlated with the display duration of the prompt information, the display duration of the prompt information may further be determined in combination with the first ratio. The first ratio, serving as a ratio of the model area of the second virtual character to the model area of the first virtual character, can reflect a size of the second virtual character with respect to the first virtual character, and can also reflect the reliability of the second virtual character hiding at the first virtual character to some extent. A larger first ratio indicates that the first virtual character can better hide the second virtual character. Therefore, setting that the display duration of the prompt information is positively correlated to the first ratio can constrain a gain effect of the prompt information on the second virtual character. A display state of the prompt information may be more comprehensively constrained in combination with the first ratio and the shadow area, thereby enhancing the reality of the game, ensuring the fairness for multiple players participating in the game, and improving the human-machine interaction efficiency.

In some embodiments, after the display duration of the prompt information is determined, the user may further prolong the display duration by completing a task, defeating enemies, or the like.

In the embodiments of this application, the display duration of the prompt information is determined based on the shadow area. This enhances the correlation between the prompt information and the shadow, so that the display duration may dynamically change along with the shadow area, improving the setting flexibility of the display duration, and facilitating the further improvement of the strategic depth of using the first virtual prop.

In an example, the client cancels the display of the prompt information in a case that the prompt information meets a disappearance condition, and skips canceling the display of a third virtual character in response to the third virtual character moving into the shadow of the first virtual character.

The disappearance condition is used for indicating whether the prompt information disappears. The disappearance condition may include at least one of the following: the display duration of the prompt information is reached, the shadow of the first virtual character disappears, and an operation of using the first virtual prop is canceled. The third virtual character is different from the first virtual character. During the period in which the display of the prompt information is canceled, although the first virtual character still has the co-movement capability, the first virtual character cannot carry another virtual character. Therefore, the display of the prompt information indicating that the first virtual character can carry another virtual character is canceled. This may facilitate the improvement of game balance. Even if the third virtual character then moves into the shadow of the first virtual character, the prompt information is not displayed based on the fact that the first virtual character cannot carry another virtual character. Therefore, the display of the third virtual character is not canceled, and restrictions are set for a game process to ensure the fairness of the game.

Operation 203: Cancel display of a second virtual character in response to the second virtual character being within a preset range of the first virtual character, a position of the second virtual character, whose display is canceled, changing along with the position of the first virtual character.

Illustratively, the preset range is a range that is preset based on the position where the first virtual character is located. In some embodiments, the preset range is a circular region within one meter around the first virtual character. Or, the preset range is a rectangular area within 0.5 meters around the first virtual character. Or, the preset range is within the shadow corresponding to the first virtual character.

Taking the preset range as the shadow corresponding to the first virtual character as an example, the display of the second virtual character is canceled in response to the second virtual character moving into the shadow of the first virtual character.

In some embodiments, the second virtual character moving into the preset range of the first virtual character may also be understood as that a distance between the second virtual character and the first virtual character is less than or equal to a preset distance. For example, the preset range is a preset distance of one meter, and the distance between the second virtual character and the first virtual character is determined in real time based on a position change of the second virtual character and the position change of the first virtual character. If the distance is less than one meter or the distance is equal to one meter, it is considered that the second virtual character moves into the preset range of the first virtual character. The implementation of the preset range is not limited herein.

The second virtual character is a virtual character different from the first virtual character, and may be in a teammate relationship with the first virtual character, or may be in a cooperation relationship with the first virtual character. In some embodiments, the forgoing prompt information is visible to the second virtual character. The second virtual character moving into the shadow of the first virtual character may refer to that the second virtual character moves into a region covered by the shadow, or may refer to that the second virtual character moves into a region covered by the prompt information.

Canceling the display of the second virtual character may refer to canceling the display of a model of the second virtual character. For example, the model of the second virtual character may be hidden in the model of the first virtual character, so as to cancel the display of the second virtual character. The model of the second virtual character may also be hidden in the shadow of the first virtual character, so as to cancel the display of the second virtual character. The model of the second virtual character may also be hidden in the prompt information, so as to cancel the display of the second virtual character. The model of the second virtual character may also not be displayed, so as to cancel the display of the second virtual character.

In an example, although the display of the second virtual character on a terminal interface is canceled when the second virtual character is within the preset range, the second virtual character is still in a fighting state in a current virtual battle, that is, the second virtual character is still alive in the game. Therefore, the second virtual character still has corresponding position information in the game, that is, the position of the second virtual character in the game is not canceled.

Illustratively, the teammate virtual character located in the same virtual faction as the second virtual character may still learn, by using a virtual map, the position of the second virtual character whose display is canceled. Or, each virtual character in the virtual battle may learn, by completing a task in the game, the position or the like of the second virtual character whose display is canceled.

In some embodiments, the co-movement function of the first virtual character enables the second virtual character to be carried by the first virtual character in a case that the second virtual character is within the preset range. At this time, the position of the second virtual character is bound to the position of the first virtual character. Therefore, the position of the second virtual character, whose display is canceled, changes along with the position of the first virtual character in the virtual environment.

Illustratively, position coordinates of the second virtual character are the same as position coordinates of the first virtual character. When the first virtual character moves in the virtual environment, the position coordinates of the second virtual character synchronously change along with the position coordinates of the first virtual character. Or, a coordinate deviation between the position coordinates of the second virtual character and the position coordinates of the first virtual character is a fixed value. When the first virtual character moves in the virtual environment, the position coordinates of the second virtual character change along with the position coordinates of the first virtual character, and a change amplitude remains consistently at a fixed value corresponding to the coordinate deviation, and so on.

In some embodiments, the position of the second virtual character is determined according to a position where the model of the second virtual character is hidden and the position of the first virtual character, so that the position of the second virtual character, whose display is canceled, changes along with the position of the first virtual character, thereby achieving an effect that the second virtual character is carried by the first virtual character.

For example, in a case that the model of the second virtual character is hidden in the model of the first virtual character, the position of the first virtual character may be directly determined as the position of the second virtual character. In a case that the model of the second virtual character is hidden in the shadow of the first virtual character, the position of the second virtual character may be determined according to the position of the first virtual character and a position of the shadow with respect to the first virtual character.

In an example, the second virtual character, whose display is canceled, shares the first angle of view with the first virtual character. To be specific, the client of the second virtual character originally displays the virtual environment picture at a second angle of view of the second virtual character. After the second virtual character is carried by the first virtual character, the client of the second virtual character is switched to synchronously display the first virtual environment picture, so that a user corresponding to the second virtual character can continue to obtain information from the first virtual environment picture.

The foregoing content describes the content that after disappearing, the second virtual character shares the first angle of view with the first virtual character. After being carried by the first virtual character, the second virtual character does not lose a game eligibility, but participates in the game process while remaining concealed from plain view. Given that the second virtual character moves in the virtual environment along with the first virtual character, and the second virtual character is subject to specific game restrictions when being carried by the first virtual character, the first angle of view of the first virtual character may be used as an angle of view taken by the second virtual character in the game, so as to display, for the second virtual character, a picture observed from the first angle of view, thereby improving the reality of the game. During this process, the server does not need to additionally generate the virtual environment picture at the second angle of view, thereby reducing a workload of generating the virtual environment picture, and saving processing resources of the server. Moreover, the user corresponding to the second virtual character does not need to perform a control operation, thereby improving user experience. The process of sharing the angle of view also facilitates the second virtual character and the first virtual character to participate in the game process more positively and cooperatively, thereby improving the cooperation between different virtual characters, and improving the human-machine interaction efficiency.

In some embodiments, when the display of the second virtual character is canceled, the client further displays a disappearance special effect, such as a special effect that the second virtual character disappears from the shadow, or a special effect that the second virtual character is hidden by the prompt information. This is not limited in the embodiments of this application.

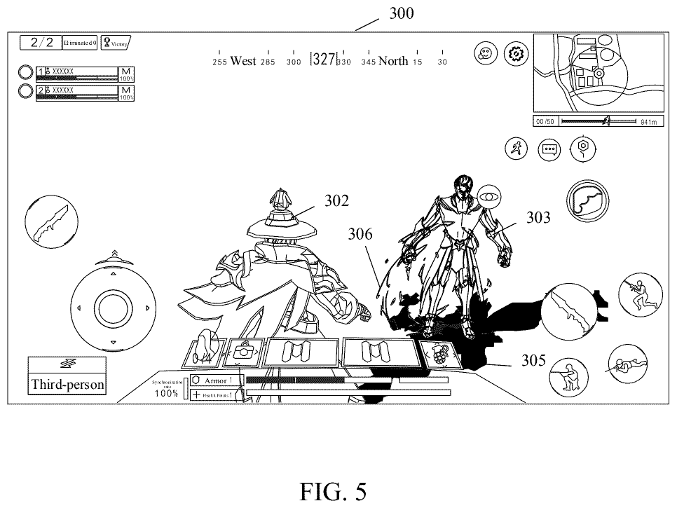

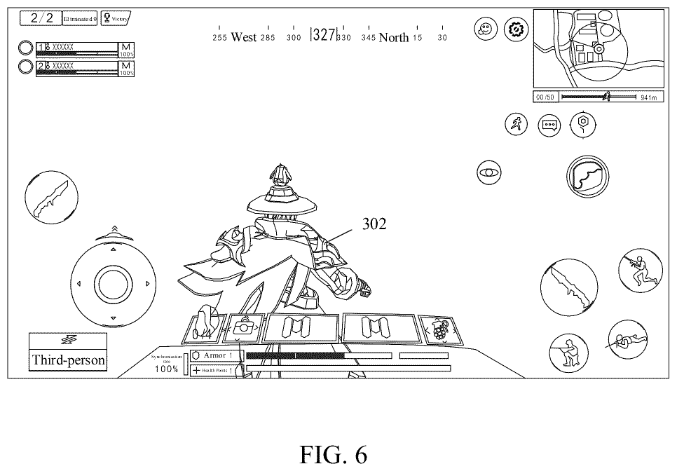

For example, referring to FIG. 5 and FIG. 6, during the display period of the prompt information 306, the client cancels the display of the second virtual character 303 in response to the second virtual character 303 moving into the shadow 305 of the first virtual character 302. The position of the second virtual character 303 changes along with a position change of the first virtual character 302. In some embodiments, the second virtual character 303 may further share the first angle of view of the first virtual character 302, that is, the second virtual character 303 watches others fight at the first angle of view.

In an example, after the second virtual character enters the shadow, the first virtual character may carry the second virtual character only after the second virtual character actively requests to be carried. Therefore, operation 203 may further include the following content:
1. Send a collision event occurring between a collider deployed within the preset range and a collider of the second virtual character to a server in a case that the collision event is detected.

The preset range is a range that is preset based on the position where the first virtual character is located. In some embodiments, the preset range is a circular region within one meter around the first virtual character. Or, the preset range is within the shadow corresponding to the first virtual character.

Taking the preset range as the shadow corresponding to the first virtual character as an example, the collision event occurring between the collider deployed within the shadow and the collider of the second virtual character is sent to the server in a case that the collision event is detected. The collider deployed within the shadow may be a collider corresponding to the shadow, or may be a collider corresponding to the prompt information. A projection region of the collider coincides with a region covered by the shadow. The collider of the second virtual character may be a collider corresponding to any part in the model, or may also refer to a collider corresponding to a foot. This is not limited in the embodiments of this application.

The collision event is configured for indicating that the collider deployed within the shadow collides with the collider of the second virtual character. After detecting the collision event, the client sends the collision event to the server. The server may be a background server corresponding to the client.
2. Cancel the display of the second virtual character in response to receiving a carrying notification from the server, the carrying notification being generated in a case that the server receives a carrying request from the client corresponding to the second virtual character, and the carrying request being configured for requesting the first virtual character to carry the second virtual character.

The carrying notification is configured for notifying the client to control the first virtual character to carry the second virtual character. The carrying notification may include identification information of the second virtual character and identification information of the first virtual character. The carrying request may include the identification information of the second virtual character and the identification information of the first virtual character. After receiving the carrying request, the server verifies the identification information of the first virtual character. After successfully verifying the identification information of the first virtual character, the server generates the carrying notification, and sends the carrying notification to the client corresponding to the first virtual character. After receiving the carrying notification, the client controls the first virtual character to carry the second virtual character, and cancels the display of the second virtual character.

The foregoing content describes a process by which the server handles the first virtual character carrying the second virtual character. The server, serving as a processing device connected to a terminal, has higher processing efficiency. If the collision event is detected, the terminal processes the collision event through the server, facilitating more comprehensive and efficient analysis of the server on the collision event. The terminal device only needs to determine, based on the carrying notification sent by the server, whether to display the second virtual character, greatly reducing calculation and storage burdens of the terminal.

In some embodiments, when the display of the second virtual character is canceled, the model of the second virtual character is hidden, so as to achieve the effect of canceling the display of the second virtual character on the interface.

In some embodiments, the model of the second virtual character is hidden in the model of the first virtual character.

Illustratively, when the second virtual character is within the preset range of the first virtual character, it is determined that the first virtual character may carry the second virtual character. Therefore, the model of the second virtual character may be hidden in the model of the first virtual character. For example, the model of the second virtual character is scaled down and hidden in the model of the first virtual character.

In some embodiments, the model of the second virtual character is hidden in the shadow of the first virtual character.

Illustratively, when the second virtual character is within the preset range of the first virtual character, it is determined that the first virtual character can carry the second virtual character. Given that the shadow of the first virtual character is usually exhibited in a dark color, such as gray, and the shadow moves along with the first virtual character, the model of the second virtual character may be hidden in the shadow of the first virtual character. For example, the model of the second virtual character is scaled down and hidden in the shadow of the first virtual character. Or, a mask effect is added to the model of the second virtual character and is then blended in the shadow of the first virtual character, and so on.

In some embodiments, the model of the second virtual character is hidden in the prompt information.

Illustratively, when the second virtual character is within the preset range of the first virtual character, it is determined that the first virtual character can carry the second virtual character. Given that the prompt information is usually implemented in a form of a floating window on the interface, the model of the second virtual character may also be hidden in the prompt information, so as to cancel the display of visual effect of the second virtual character on the interface.

The foregoing content describes that the model of the second virtual character is hidden to cancel the display of content of the second virtual character. By the process of hiding the model, visual disturbance on the interface can be reduced, an effect that the second virtual character disappears is presented to a target user, which is more in line with the purpose of interface display. This offers more personalized and immersive game experience to the player and facilitates the improvement of human-machine interaction efficiency.

In an example, while canceling the display of the second virtual character, the client also cancels the display of the prompt information, so that another virtual character cannot be carried by the first virtual character any more.

In an example, after the first virtual character carries the second virtual character, the second virtual character may further be released from the carrying of the first virtual character. This may include at least one of the following cases:
1. redisplay the second virtual character next to a position of the first virtual character in a case that a remaining effective duration of the first virtual prop used by the first virtual character is 0.

The character state of the first virtual character meeting a preset condition includes the first virtual character using the first virtual prop. The remaining effective duration is a remaining duration for which the first virtual character still has the co-movement capability. In a case that the remaining effective duration of the first virtual prop is 0, the first virtual character loses the co-movement capability, the first virtual character cannot carry the second virtual character any more, and the client needs to redisplay the second virtual character. The remaining effective duration may be set and adjusted according to an actual use requirement. This is not limited in the embodiments of this application.

For example, in a case that the remaining effective duration of the first virtual prop is 0, the client may redisplay the model of the second virtual character on the shadow of the first virtual character, or may display the model of the second virtual character at any position around the first virtual character.
2. Redisplay the second virtual character next to the position of the first virtual character in a case that a client corresponding to the second virtual character initiates a release request.

The release request is configured for requesting to release from the carrying of the first virtual character. The client corresponding to the second virtual character may send the release request to the server. The server generates a release notification after receiving the release request, and sends the release notification to the client corresponding to the first virtual character. After receiving the release notification, the client corresponding to the first virtual character controls the first virtual character to end carrying the second virtual character, and redisplay the second virtual character next to the position of the first virtual character. In this way, the second virtual character can be actively released from the carrying of the first virtual character, thereby improving the flexibility of operations. To be specific, even if the first virtual character has the co-movement capability, the second virtual character still has a particular self-determined selection right, and may select to be carried by the first virtual character, or may select not to be carried by the first virtual character, thereby enhancing the flexibility of the player in terms of controlling the virtual character to play the game.
3. Redisplay the second virtual character next to the position of the first virtual character in a case that the first virtual character enters a second state, the second state including at least one of the following: a virtual health value being 0, a knocked-down state, or an injured state.

That is, in a case that the first virtual character enters the second state, the first virtual character loses the co-movement capability, the first virtual character cannot carry the second virtual character any more, and the client needs to redisplay the second virtual character. The injured state may be a state in which the virtual health value is less than a health value threshold.
4. Redisplay the second virtual character next to the position of the first virtual character in a case that the shadow of first virtual character disappears.

Illustratively, the display of the second virtual character is canceled by hiding the second virtual character in the shadow of the first virtual character. Therefore, when the shadow of the first virtual character disappears, the display of the second virtual character may be redisplayed next to the position of the first virtual character. For example, when the first virtual character walks to a space without light, the shadow of the first virtual character disappears, and the second virtual character is redisplayed. Or, when the virtual health value of the first virtual character is 0, the first virtual character and the shadow disappear together, and then the second virtual character is displayed. Therefore, the shadow of the first virtual character disappearing may be considered as that the first virtual character loses the co-movement capability of carrying the virtual character. That is, the foregoing co-movement capability may be associated with the shadow of the first virtual character, facilitating the improvement of reasonableness of the co-movement capability. Moreover, enemies may perform targeted deployment based on this feature, thereby improving the strategic depth of the game.

The foregoing content describes several exemplary manners in which the second virtual character is released from the carrying of the first virtual character. These exemplary manners include that the first virtual character loses the co-movement capability of carrying the second virtual character due to changes in its own state or a state of a held prop, so as to redisplay the second virtual character, and also include that the second virtual character decides to release from the carrying of the first virtual character, so as to redisplay the second virtual character. The determination of whether to redisplay the second virtual character in at least one of a plurality of manners helps enhance the game reality and provide stronger game flexibility to the player at the same time, so that the interface display better meets the expectation of the player, balances the capabilities of all game participants, and contributes to reasonable allocation of in-game data resources while ensuring the fairness of the game.

In some embodiments, when redisplaying the second virtual character, the client further displays a redisplay special effect, such as a special effect that the second virtual character reappears in the shadow, or a special effect that the second virtual character redisplays from the prompt information. This is not limited in the embodiments of this application.

In some embodiments, during a process in which the first virtual character carries the second virtual character, if the first virtual character is attacked, the attack does not affect the second virtual character. The second virtual character in a carried state loses an attack capability, and cannot attack enemies but may watch others fight.

In conclusion, according to the technical solution provided in the embodiments of this application, when the character state of the first virtual character meets the preset condition, it indicates that the first virtual character has the capability of carrying another virtual character, so that when the second virtual character moves into the preset range of the first virtual character, the first virtual character can achieve the goal of carrying the second virtual character without the aid of a virtual vehicle. This avoids a constraint problem caused by relying on the virtual vehicle to carry the virtual character, and effectively improves the convenience and efficiency of operations. In addition, in a scenario where the second virtual character needs to evade an enemy virtual character, by using the technical solution provided in this application, the second virtual character may hide on the first virtual character, without additionally searching for a virtual building, an obstacle, or the like for evasion. This facilitates further improvement of the convenience and efficiency of operations.

In addition, whether to display the prompt information is determined in combination with the trigger condition and the shadow area, so that the user needs to consider the trigger condition and the shadow area when using the first virtual prop, thereby improving the strategic depth and balance of using the first virtual prop. In addition, the first virtual prop cannot be triggered by limiting the first virtual character in some states, thereby improving the balance of using the first virtual prop.

In addition, the display duration of the prompt information is determined based on the shadow area. This enhances the correlation between the prompt information and the shadow, so that the display duration may dynamically change along with the shadow area, improving the setting flexibility of the display duration, and facilitating the further improvement of the strategic depth of using the first virtual prop.

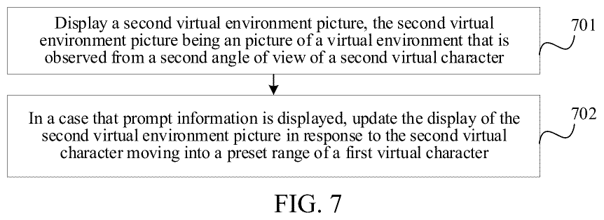

Referring to FIG. 7, a flowchart of a method for controlling a virtual character according to another embodiment of this application is shown. An execution entity of the operations of the method may be the terminal device 10 in a control system shown in FIG. 1, for example, the client in the terminal device 10. The method may include the following operations (701-702).

Operation 701: Display a second virtual environment picture, the second virtual environment picture being a picture of a virtual environment that is observed from a second angle of view of a second virtual character.

The virtual environment is an environment displayed (or provided) when a client of an application program (for example, a game application program) runs on the terminal device. The foregoing virtual environment picture is a picture obtained by observing the virtual environment. For example, the second virtual environment picture is a virtual environment picture obtained through observing the virtual environment by the second virtual character. The foregoing virtual character may be a character controlled by a user account in the application program. For example, the second virtual character may be a virtual character controlled by a currently logged-in user account in the terminal device.

The second virtual character is different from the first virtual character, and the client corresponding to the second virtual character and the client corresponding to the first virtual character may be clients of a same application program in different terminal devices. The foregoing second virtual environment picture may be displayed by the client corresponding to the second virtual character. In some embodiments, the second virtual character may be in a teammate relationship, a cooperation relationship, or the like with the first virtual character.

The foregoing second angle of view is an angle of view of the second virtual character, and may be set and adjusted according to an actual use requirement. For example, the second angle of view may be a first-person angle of view, a third-person angle of view, or the like that is based on the second virtual character. This is not limited in the embodiments of this application.

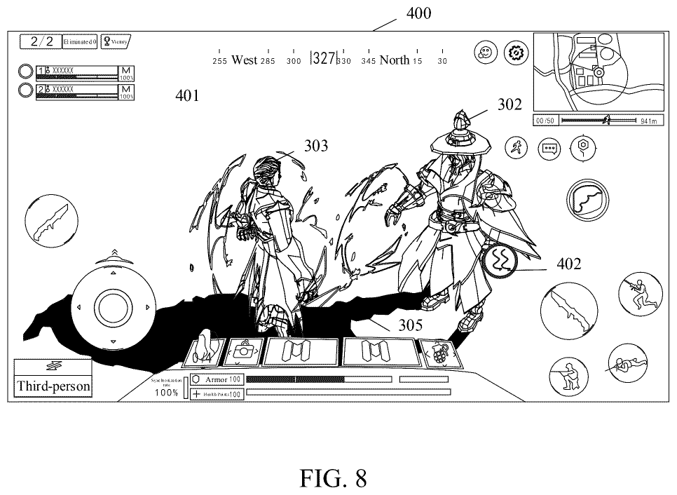

For example, referring to FIG. 8 and FIG. 3, the client corresponding to the second virtual character displays a second virtual environment picture 401 on a user interface 400. The second virtual environment picture 401 is a picture of the virtual environment that is observed from the third-person angle of view of the second virtual character 303. The second virtual environment picture 401 includes the first virtual character 302 and the second virtual character 303 located in the virtual environment. The first virtual character 302 and the second virtual character 303 may be controlled by a user to perform activities, for example, releasing a skill, using a virtual prop, walking, or running, in the virtual environment.

Operation 702: In a case that prompt information is displayed, update the display of the second virtual environment picture in response to the second virtual character moving into the preset range of the first virtual character.

The prompt information is configured for indicating that the first virtual character has a capability of carrying another virtual character.

In a case that the prompt information is displayed on the shadow of the first virtual character, the user can determine that the first virtual character at this time has a capability of carrying another virtual character (i.e. a co-movement capability). For example, the co-movement capability in the embodiments of this application may be represented as: for the second virtual character, the second virtual character watches others fight at the second angle of view of the second virtual character, and a position of the second virtual character changes along with a position change of the first virtual character. The second virtual character is invisible to an enemy virtual character. This increases the difficulty for enemies to locate targets, and increases a fighting advantage between the first virtual character and the second virtual character, thereby improving the flexibility of operations, and further improving the user experience. The second virtual character is also invisible to the first virtual character, but related information is displayed on the user interface, so as to prompt that the first virtual character is carrying the first virtual character.

In some embodiments, the prompt information may be displayed in a case that the first virtual character uses the foregoing first virtual prop. The prompt information is visible to the second virtual character. The prompt information in this application is visual content, such as text prompt information, image prompt information, animation prompt information, and special effect prompt information.

In some embodiments, because the second virtual character is carried by the first virtual character, the display of the second virtual character on a terminal interface corresponding to another player is canceled. Canceling the display of the second virtual character may refer to canceling the display of a model of the second virtual character. For example, the model of the second virtual character may be hidden in the model of the first virtual character, so as to cancel the display of the second virtual character. The model of the second virtual character may also be hidden in the shadow of the first virtual character, so as to cancel the display of the second virtual character. The model of the second virtual character may also be hidden in the prompt information, so as to cancel the display of the second virtual character. The model of the second virtual character may also not be displayed, so as to cancel the display of the second virtual character.

In an example, a collider is deployed on the shadow of the first virtual character, and in a case that a collision event occurring between a collider corresponding to the second virtual character and the collider deployed on the shadow of the first virtual character is detected, the client determines that the second virtual character moves into the shadow of the first virtual character. This collision event may be detected and uploaded by the client corresponding to the first virtual character, or may be detected and uploaded by the client corresponding to the second virtual character, or may be detected and obtained by a server. This is not limited in the embodiments of this application.

In an example, the client sends a carrying request to the server in response to the second virtual character moving into the shadow of the first virtual character, the carrying request being configured for requesting the first virtual character to carry the second virtual character; and cancels the display of the second virtual character on the terminal interface of the another player in response to receiving the carrying notification from the server. This carrying notification is also synchronously sent to the client corresponding to the first virtual character. Therefore, in a case that the carrying notification is received, the client corresponding to the second virtual character can determine that the first virtual character already starts to carry the second virtual character, and can cancel the display of the second virtual character.

In an example, to prevent the second virtual character from being carried by the first virtual character by mistake, the embodiments of this application further support secondary confirmation for the second virtual character. In this case, the embodiments of this application may further include the following content: additionally display a first control in response to the second virtual character moving into a shadow of the first virtual character; send a carrying request to a server in response to an operation of triggering the first control, the carrying request being configured for requesting the first virtual character to carry the second virtual character; and cancel the display of the second virtual character in response to receiving a carrying notification from the server. The first control is configured to generate a carrying request.

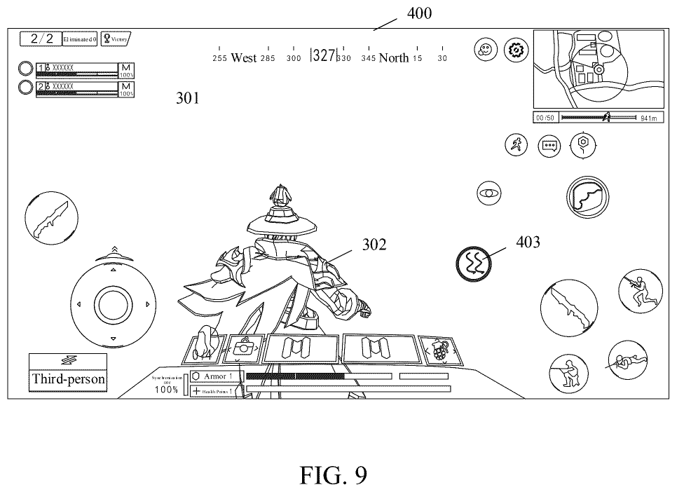

For example, referring to FIG. 8 and FIG. 9, a first control 402 is additionally displayed on the user interface 400 in response to the second virtual character 303 moving into the shadow 305 of the first virtual character 302. The client corresponds to the second virtual character 303 sends the carrying request to the server in response to a trigger operation of the user on the first control. In response to receiving the carrying notification from the server, the client corresponding to the second virtual character 303 cancels the display of the second virtual character 303, and displays the virtual environment picture of the first virtual character 302 at the third-person angle of view.

The foregoing content describes a process of reminding, by using the first control, the second virtual character to determine whether to be carried. To prevent the second virtual character from being carried by the first virtual character by mistake, the second virtual character is prompted for selection by displaying the first control. Only when the player controlling the second virtual character triggers the first control will the server confirm that the second virtual character is carried by the first virtual character. This ensures the autonomy of the player in a game process, provides stronger clarity for interaction, avoids a problem of incorrect carrying caused by an incorrect operation, improves the game accuracy and player experience, can also accelerate a player response speed by leveraging an instant feedback of the first control, optimizes game resource allocation, and reduces a data processing amount.

In an exemplary embodiment, the preset range of the first virtual character is the shadow of the first virtual character, and when the second virtual character moves into the shadow of the first virtual character, the display of the second virtual environment picture is updated, where the position of the second virtual character, whose display is canceled, in the virtual environment changes along with the position of the first virtual character.

In some embodiments, the client of the second virtual character updates and displays the second virtual environment picture based on a position change of the second virtual character. The position of the second virtual character may be determined according to a position to which the model of the second virtual character is hidden and the position of the first virtual character. For example, in a case that the model of the second virtual character may be hidden in the shadow of the first virtual character, the position of the second virtual character may be determined according to the position of the first virtual character and a position of the shadow with respect to the first virtual character. In this process, the user corresponding to the second virtual character may further switch the second angle of view of the second virtual character, thereby improving the flexibility of operations.

The forgoing operation 701 to operation 702 describe the content displayed on a terminal corresponding to the second virtual character. The second virtual character, serving as another player that controls virtual characters other than the first virtual character, may observe the virtual environment according to the second angle of view of the second virtual character to observe the second virtual environment picture. If the prompt information is displayed, the player may enable the first virtual character to carry the second virtual character by controlling the second virtual character to move into the preset range of the first virtual character. The second virtual character may be stealth in the virtual environment, effectively avoiding an enemy attack, and further facilitating the improvement of tactical flexibility. A virtual battle is performed in cooperation with the first virtual character in a manner such as sudden attack or secret information collection, enhancing the complexity and playability of the game.

In an example, the client of the second virtual character is fixed at the first angle of view of the first virtual character to display the virtual environment picture. The embodiments of this application may further include the following content: switch the second virtual environment picture to a first virtual environment picture for displaying, the first virtual environment picture being a picture of the virtual environment that is observed from a first angle of view of the first virtual character; and update the display of the first virtual environment picture based on a position change of the first virtual character.

For example, referring to FIG. 8 and FIG. 9, in response to the second virtual character being carried by the first virtual character, the user interface 400 corresponding to the client of the second virtual character switches the second virtual environment picture 401 to the first virtual environment picture 301 for displaying, and updates the display of the first virtual environment picture 301 along with the position change of the first virtual character.

The foregoing content describes a process in which the virtual environment picture may be displayed at the first angle of view of the first virtual character after the second virtual character is carried by the first virtual character. Since the second virtual character is carried by the first virtual character, the virtual environment that is observed from the second angle of view of the second virtual character may not present much information at this time. Therefore, observing the virtual environment at the first angle of view helps enhance the perception of the second virtual character on the virtual environment, and also helps improve cooperative effectiveness between the second virtual character and the first virtual character, facilitates coordinated actions among different virtual characters, improves interaction efficiency and interesting of multiple players in the game, and improves the human-machine interaction efficiency.

In an example, after the display of the second virtual character is canceled, the client corresponding to the second virtual character further supports the second virtual character being actively released from of the carrying of the first virtual character, thereby helping improve the flexibility of operations. In this case, the embodiments of this application may further include the following content: display a second control; send a release request to a server in response to an operation of triggering the second control, the release request being configured for requesting to release from the first virtual character; redisplay the second virtual character next to the position of the first virtual character in response to receiving a release notification from the server; and redisplay the second virtual environment picture.

The second control is configured to generate a release request. In some embodiments, the second control is a control that is additionally displayed on the interface after the display of the second virtual character is canceled. For example, after the display of the second virtual character is canceled, the client of the first virtual character replaces the first control with the second control for displaying. In this way, excessive occupation of the user interface can be avoided, thereby keeping the simplicity of the user interface. The release notification is configured for notifying the client to control the second virtual character to be released from the carrying of the first virtual character. Since the release notification is also synchronously sent to the client of the first virtual character, the client of the first virtual character and the client of the second virtual character may synchronously redisplay the second virtual character next to the position of the first virtual character.

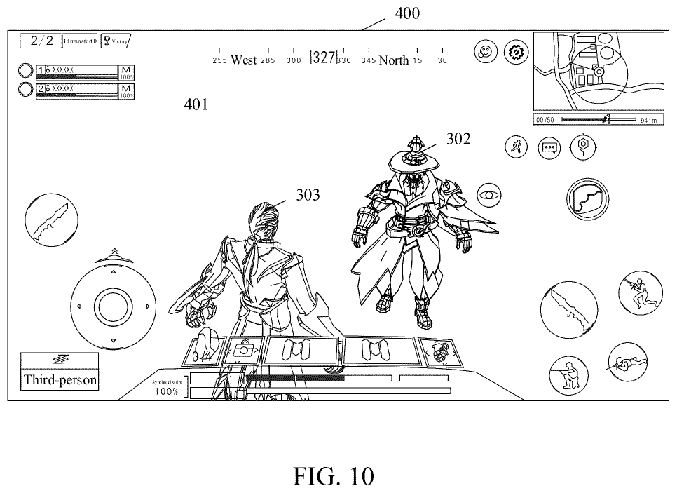

For example, referring to FIG. 9 and FIG. 10, a second control 403 is displayed on the user interface 400. In response to the trigger operation performed by the user on the second control 403, the user interface 400 redisplays the second virtual character 303 next to the position of the first virtual character 302, and switches the first virtual environment picture 301 to the second virtual environment picture 401 for displaying.

By rationally utilizing the co-movement capability to coordinate between the first virtual character and the second virtual character, an unexpected fighting effect can be realized, thereby helping improve the interestingness of the game and also improving the adhesiveness of users. In addition, by using the second control, the player controlling the second virtual character may further determine whether to be released from the carrying. This ensures the autonomy of the player in the game, facilitates the second virtual character to effectively complete a game task of the player while assisting the first virtual character in participating in a virtual battle, and improves the human-machine interaction efficiency.

In conclusion, when the character state of the first virtual character meets the preset condition, it indicates that the first virtual character has the capability of carrying another virtual character, so that when the second virtual character moves into the preset range of the first virtual character, the first virtual character can achieve the goal of carrying the second virtual character without the aid of a virtual vehicle. This avoids a constraint problem caused by relying on the virtual vehicle to carry the virtual character, and effectively improves the convenience and efficiency of operations. In addition, in a scenario where the second virtual character needs to evade an enemy virtual character, by using the technical solution provided in this application, the second virtual character may hide on the first virtual character, without additionally searching for a virtual building, an obstacle, or the like for evasion. This facilitates further improvement of the convenience and efficiency of operations.

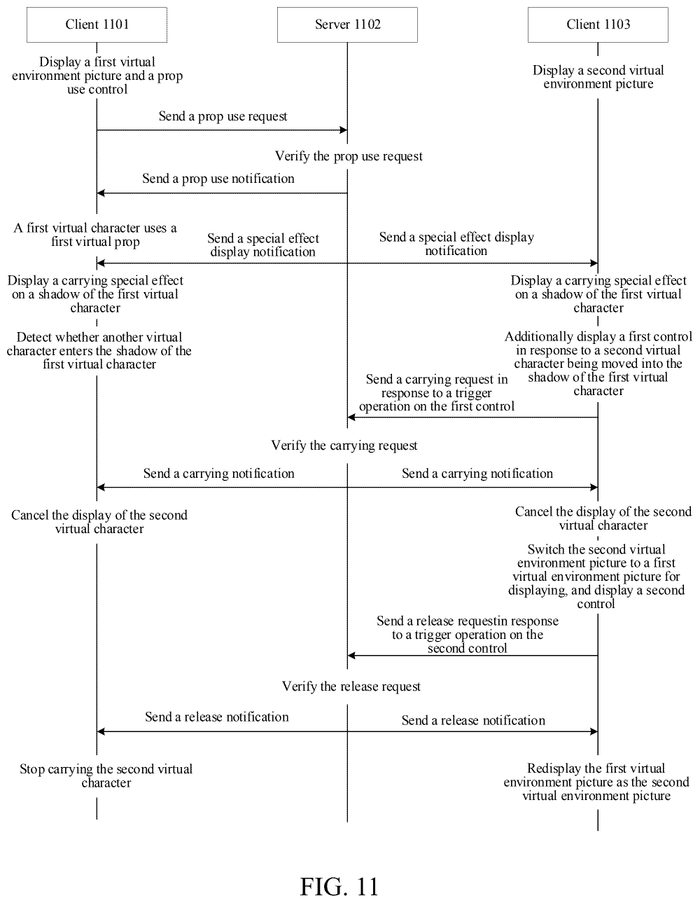

Referring to FIG. 11, a flowchart of a method for controlling a virtual character according to another embodiment of this application is shown. This method may include the following operations.
1. A prop use control corresponding to a first virtual prop and a first virtual environment picture are displayed on a user interface of a client 1101, the first virtual environment picture being a picture of a virtual environment that is observed from a first angle of view of a first virtual character.
2. The client 1101 sends a prop use request to a server 1102 in response to a trigger operation for the prop use control, the prop use request including identification information of the first virtual character and identification information of the first virtual prop.
3. The server 1102 verifies the prop use request after receiving the prop use request.
4. The server 1102 sends a use notification to the client 1101 after successfully verifying the prop use request, the use notification being configured for notifying the client 1101 to control the first virtual character to use the first virtual prop.
5. After receiving the use notification, the client 1101 displays a process in which the first virtual character uses the first virtual prop.
6. After receiving a special effect display notification from the server 1102, the client 1101 displays a carrying special effect, such as “fog,” “time gate,” “teleportation circle,” and “wormhole,” on a shadow of the first virtual character.
7. The client 1101 detects whether another virtual character enters the shadow of the first virtual character, and displays a remaining effective duration of the first virtual prop at the same time, for example, displays the remaining effective duration of the first virtual prop in a form of countdown. In some embodiments, the remaining effective duration may be counted by the server 1102. In a case that the remaining effective duration is 0, the server 1102 notifies the client 1101 to stop displaying the remaining effective duration of the first virtual prop, and switch the first virtual prop to a disabled state. In this case, the first virtual character does not have a co-movement capability. When an energy value of the first virtual prop reaches a maximum energy value, the first virtual prop can be used again.
8. The client 1103 displays a second virtual environment picture, the second virtual environment picture being a picture of the virtual environment that is observed from a second angle of view of a second virtual character. In some embodiments, the second virtual environment picture includes the first virtual character and the second virtual character.

In some embodiments, virtual environment pictures respectively corresponding to various clients in the embodiments of this application may be uniformly generated by the server 1102, so that the virtual environment pictures displayed by the various clients remain associated and uniform, thereby forming an effect that multiple virtual characters perform activities in the virtual environment.
9. The client 1103 displays the carrying special effect on the shadow of the first virtual character after receiving the special effect display notification from the server 1102. In some embodiments, in a case that another client also needs to display the carrying special effect, the server 1102 also sends the special effect display notification to the another client.
10. The client 1103 additionally displays a first control in response to the second virtual character moving into a shadow of the first virtual character.
11. The client 1103 sends a carrying request to the server 1102 in response to a trigger operation for the first control, the carrying request being configured for requesting the first virtual character to carry the second virtual character.
12. The server 1102 verifies the carrying request after receiving the carrying request. For example, the carrying request is verified according to a virtual character information, a virtual character state, or the like.
13. The server 1102 generates a carrying notification after successfully verifying the carrying request, and sends the carrying notification to the client 1101 and the client 1103.
14. The client 1101 cancels the display of the second virtual character, and displays, on the user interface, a prompt icon indicating that the second virtual character is carried. The client 1103 also cancels the display of the second virtual character. At this time, the second virtual character is carried by the first virtual character.
15. The client 1103 switches the second virtual environment picture to the first virtual environment picture for displaying, and displays the second control.
16. The client 1103 sends a release request to the server 1102 in response to a trigger operation for the second control, the release request being configured for requesting to release from the first virtual character.
17. The client 1103 redisplays the second virtual character next to a position of the first virtual character in response to receiving a release notification from the server 1102. The client 1101 also redisplays the second virtual character next to the position of the first virtual character in response to receiving the release notification from the server 1102. At this time, the second virtual character is released from the carrying of the first virtual character. The server 1102 generates and sends the release notification after successfully verifying the release request.
18. The client 1103 redisplays the first virtual environment picture as the second virtual environment picture.

In conclusion, when the character state of the first virtual character meets the preset condition, it indicates that the first virtual character has the capability of carrying another virtual character, so that when the second virtual character moves into the preset range of the first virtual character, the first virtual character can achieve the goal of carrying the second virtual character without the aid of a virtual vehicle. This avoids a constraint problem caused by relying on the virtual vehicle to carry the virtual character, and effectively improves the convenience and efficiency of operations. In addition, in a scenario where the second virtual character needs to evade an enemy virtual character, by using the technical solution provided in this application, the second virtual character may hide on the first virtual character, without additionally searching for a virtual building, an obstacle, or the like for evasion. This facilitates further improvement of the convenience and efficiency of operations.

The following is an apparatus embodiment of this application, which can be configured to perform the method embodiments of this application. For details not disclosed in the apparatus embodiments of this application, refer to the method embodiments of this application.

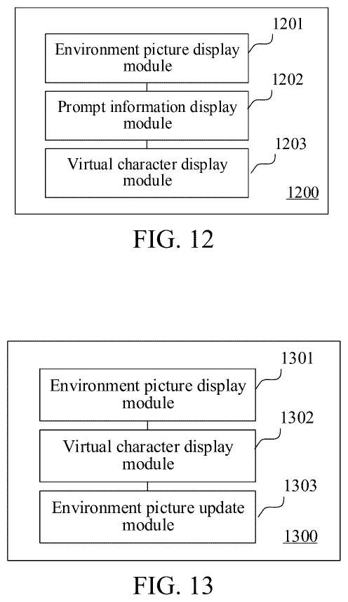

Referring to FIG. 12, a block diagram of an apparatus for controlling a virtual character according to an embodiment of this application is shown. The apparatus has a function of implementing the foregoing method examples, and the function may be implemented by hardware or may be implemented by hardware executing corresponding software. The apparatus may be the terminal device described above, or may be arranged in a terminal device. As shown in FIG. 12, the apparatus 1200 includes: an environment picture display module 1201, a prompt information display module 1202, and a virtual character display module 1203.

The environment picture display module 1201 is configured to display a first virtual environment picture, the first virtual environment picture being a picture of a virtual environment that is observed from a first angle of view of a first virtual character.

The prompt information display module 1202 is configured to display prompt information in response to a character state of the first virtual character meeting a preset condition, the prompt information being configured for indicating that the first virtual character has a capability of carrying another virtual character.

The virtual character display module 1203 is configured to cancel the display of the second virtual character in response to a second virtual character being within a preset range of the first virtual character, a position of the second virtual character, whose display is canceled, changing along with the position of the first virtual character.

In some embodiments, the virtual character display module 1203 is configured to: cancel the display of the second virtual character in response to the second virtual character moving into a shadow of the first virtual character.

In some embodiments, the virtual character display module 1203 is configured to: send a collision event occurring between a collider deployed within the preset range and a collider of the second virtual character to a server in a case that the collision event is detected; and cancel the display of the second virtual character in response to receiving a carrying notification from the server,
the carrying notification being generated in a case that the server receives a carrying request from a client corresponding to the second virtual character, and the carrying request being configured for requesting the first virtual character to carry the second virtual character.

In some embodiments, a model of the second virtual character is hidden in a model of the first virtual character. Or, the model of the second virtual character is hidden in the shadow of the first virtual character. Or, the model of the second virtual character is hidden in the prompt information.

In some embodiments, the second virtual character, whose display is canceled, shares the first angle of view with the first virtual character.

In some embodiments, the prompt information display module 1202 is configured to: in response to receiving an operation of controlling the first virtual character to use a first virtual prop, obtain a shadow area corresponding to the shadow of the first virtual character if the first virtual prop meets a trigger condition, a character state of the first virtual character reaching the preset state including the first virtual character using the first virtual prop; and display the prompt information on the shadow of the first virtual character in a case that the shadow area is greater than or equal to a first threshold.

In some embodiments, the prompt information display module 1202 is further configured to: in a case that the shadow area is greater than or equal to the first threshold, skip displaying the prompt information if the first virtual character is in a first state, the first state including at least one of the following: a knocked-down state, being in a virtual vehicle, a climbing state, a rescue state, or a virtual health value being 0.

In some embodiments, the virtual character display module 1203 is further configured to: redisplay the second virtual character next to a position of the first virtual character in a case that a remaining effective duration of a first virtual prop used by the first virtual character is 0, a character state of the first virtual character reaching the preset state including the first virtual character using the first virtual prop; or, redisplay the second virtual character next to the position of the first virtual character in a case that a client corresponding to the second virtual character initiates a release request; or, redisplay the second virtual character next to the position of the first virtual character in a case that the first virtual character enters a second state, the second state including at least one of the following: a virtual health value being 0, a knocked-down state, or an injured state;
or, redisplay the second virtual character next to the position of the first virtual character in a case that the shadow of the first virtual character disappears.

In some embodiments, the apparatus 1200 further includes: a shadow area obtaining module and a display duration determining module (not shown).

The shadow area obtaining module is configured to obtain a shadow area of the shadow when the first virtual prop is used.

The display duration determining module is configured to determine a display duration of the prompt information according to the shadow area, the display duration of the prompt information being positively correlated with the shadow area.

In some embodiments, the apparatus 1200 further includes: a first ratio obtaining module (not shown).

The first ratio obtaining module is configured to obtain a first ratio of a model area of the second virtual character to the model area of the first virtual character.

The display duration determining module is configured to determine a display duration of the prompt information according to the first ratio and the shadow area, the display duration of the prompt information being positively correlated with the first ratio, and the display duration of the prompt information being positively correlated with the shadow area.

In some embodiments, the prompt information display module 1202 is further configured to cancel the display of the prompt information in a case that the prompt information meets a disappearance condition.

The virtual character display module 1203 is further configured to skip canceling the display of a third virtual character in response to the third virtual character moving into the shadow of the first virtual character.

In conclusion, when the character state of the first virtual character meets the preset condition, it indicates that the first virtual character has the capability of carrying another virtual character, so that when the second virtual character moves into the preset range of the first virtual character, the first virtual character can achieve the goal of carrying the second virtual character without the aid of a virtual vehicle. This avoids a constraint problem caused by relying on the virtual vehicle to carry the virtual character, and effectively improves the convenience and efficiency of operations. In addition, in a scenario where the second virtual character needs to evade an enemy virtual character, by using the technical solution provided in this application, the second virtual character may hide on the first virtual character, without additionally searching for a virtual building, an obstacle, or the like for evasion. This facilitates further improvement of the convenience and efficiency of operations.

Referring to FIG. 13, a block diagram of an apparatus for controlling a virtual character according to another embodiment of this application is shown. The apparatus has a function of implementing the foregoing method examples, and the function may be implemented by hardware or may be implemented by hardware executing corresponding software. The apparatus may be the terminal device described above, or may be arranged in a terminal device. As shown in FIG. 13, the apparatus 1300 includes: an environment picture display module 1301, a virtual character display module 1302, and an environment picture update module 1303.

The environment picture display module 1301 is configured to display a second virtual environment picture, the second virtual environment picture being a picture of a virtual environment that is observed from a second angle of view of a second virtual character.

The virtual character display module 1302 is configured to: in a case that prompt information is displayed, update the display of the second virtual environment picture in response to the second virtual character moving into a preset range of a first virtual character, the prompt information being configured for indicating that the first virtual character has a capability of carrying another virtual character, a position of the second virtual character, whose display is canceled, in the virtual environment changing along with the position of the first virtual character.

In some embodiments, the virtual character display module 1302 is configured to:
switch the second virtual environment picture to a first virtual environment picture for displaying, the first virtual environment picture being a picture of the virtual environment that is observed from a first angle of view of the first virtual character; and
update the display of the first virtual environment picture based on a position change of the first virtual character.

In some embodiments, the virtual character display module 1302 is configured to:
additionally display a first control in response to the second virtual character moving into a shadow of the first virtual character;
send a carrying request to a server in response to an operation of triggering the first control, the carrying request being configured for requesting the first virtual character to carry the second virtual character; and
update the display of the second virtual environment picture in response to receiving a carrying notification from the server.

In some embodiments, a model of the second virtual character is hidden in a model of the first virtual character. Or, the model of the second virtual character is hidden in the shadow of the first virtual character. Or, the model of the second virtual character is hidden in the prompt information.

In some embodiments, the apparatus 1300 further includes: a second control display module and a release request generation module (not shown).

The second control display module is configured to display a second control.

The release request generation module is configured to send a release request to a server in response to an operation of triggering the second control, the release request being configured for requesting to release from the first virtual character.

The virtual character display module 1302 is configured to: send a release request to a server in response to an operation of triggering the second control, the release request being configured for requesting to release from the first virtual character; and in response to receiving a release notification from the server, display the second virtual environment picture of the virtual environment observed from the second angle of view of the second virtual character, the second virtual character being redisplayed next to the position of the first virtual character.

In conclusion, when the character state of the first virtual character meets the preset condition, it indicates that the first virtual character has the capability of carrying another virtual character, so that when the second virtual character moves into the preset range of the first virtual character, the first virtual character can achieve the goal of carrying the second virtual character without the aid of a virtual vehicle. This avoids a constraint problem caused by relying on the virtual vehicle to carry the virtual character, and effectively improves the convenience and efficiency of operations. In addition, in a scenario where the second virtual character needs to evade an enemy virtual character, by using the technical solution provided in this application, the second virtual character may hide on the first virtual character, without additionally searching for a virtual building, an obstacle, or the like for evasion. This facilitates further improvement of the convenience and efficiency of operations.

When the apparatus provided in the foregoing embodiments implements functions of the apparatus, the division of the foregoing functional modules is merely an example for description. In the practical application, the functions may be assigned to and completed by different functional modules according to the requirements, that is, the internal structure of the device is divided into different functional modules, to implement all or some of the functions described above. In addition, the apparatus and method embodiments provided in the foregoing embodiments belong to the same conception. For the specific implementation process, refer to the method embodiments. Details are not described herein again.

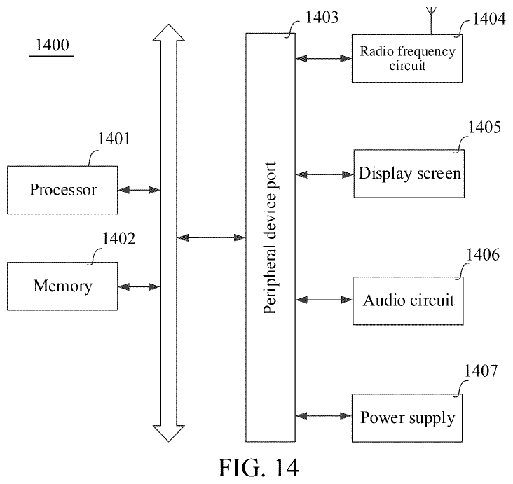

Referring to FIG. 14, a structural block diagram of a terminal device according to an embodiment of this application is shown. The terminal device 1400 is configured to implement the method for controlling a virtual character provided in the foregoing embodiments. The terminal device 1400 may be the terminal device 10 in the control system shown in FIG. 1. Specifically, the terminal device 1400 generally includes: a processor 1401 and a memory 1402.

In some embodiments, the processor 1401 may include one or more processing cores, for example, a 4-core processor and an 8-core processor. The processor 1401 may be implemented in at least one hardware form of digital signal processing (DSP), a field-programmable gate array (FPGA), and a programmable logic array (PLA). In some embodiments, the memory 1402 may include one or more computer-readable storage media. The computer-readable storage media may be non-transient. The memory 1402 may also include a high-speed random access memory, as well as non-volatile memory, such as one or more disk storage devices and flash storage devices. In some embodiments, the non-transitory computer-readable storage medium in the memory 1402 is configured to store a computer program, the computer program being configured to be executed by one or more processors to implement the foregoing virtual character switching method.

In some embodiments, the terminal device 1400 may alternatively include: a peripheral device interface 1403 and at least one peripheral device. The processor 1401, the memory 1402, and the peripheral interface 1403 may be connected through a bus or a signal wire. Each peripheral device may be connected to the peripheral device interface 1403 by using a bus, a signal wire, or a circuit board. Specifically, the peripheral device includes at least one of a radio frequency circuit 1404, a display screen 1405, an audio circuit 1406, or a power supply 1407.

A person skilled in the art may understand that the structure shown in FIG. 14 constitutes no limitation on the terminal device 1400, and the terminal device may include more or fewer components than those shown in the figure, or a combination of some components, or have a different arrangement of components.

In some embodiments, a computer-readable storage medium is further provided, the computer-readable storage medium having a computer program stored therein, and the computer program being executed by a processor to implement the foregoing method for controlling a virtual character. In some embodiments, a computer program product is further provided, the computer program product including a computer program, and the computer program being stored in a computer-readable storage medium. A processor of a terminal device reads the computer program from the computer-readable storage medium, and executes the computer program, to cause the terminal device to perform the foregoing method for controlling a virtual character.

In the embodiments of this application, before collection of relevant data of the user and during the collection of the relevant data of the user, a prompt interface or a pop-up window may be displayed, or audio prompt information may be outputted. The prompt interface, the pop-up window, or the audio prompt information is configured for prompting the user that the relevant data of the user is currently collected. In this way, in this application, only after a confirmation operation transmitted by the user for the prompt interface or the pop-up window is obtained, a relevant operation of obtaining the relevant data of the user is started to be performed. Otherwise (in other words, the confirmation operation transmitted by the user for the prompt interface or the pop-up window is not obtained), the relevant operation of obtaining the relevant data of the user is ended, in other words, the relevant data of the user is not obtained. In other words, all user data collected in this application is strictly processed according to requirements of relevant national laws and regulations. The obtained personal information is collected with consent and authorization of the user within the scope of authorization of the laws and regulations and a subject of the personal information. Performing of subsequent data use and processing, and collection, use, and processing of the relevant user data are required to comply with relevant laws, regulations, and standards of relevant countries and regions. For example, the virtual environment, the virtual character, the virtual prop, the operations, and the like involved in this application are obtained with full authorization.

“A plurality of” mentioned herein means two or more. “And/or” describes an association relationship for describing associated objects and represents that three relationships may exist. For example, A and/or B may represent the following three cases: Only A exists, both A and B exist, and only B exists. The character “/” generally indicates an “or” relationship between the associated objects. In addition, the operation numbers described in this specification merely schematically show a possible execution sequence of the operations. In some other embodiments, the above operations may not be performed according to the number sequence. For example, two operations with different numbers may be performed simultaneously, or two operations with different numbers may be performed according to a sequence contrary to the sequence shown in the figure. This is not limited in the embodiments of this application.

The foregoing descriptions are merely exemplary embodiments of this application, but are not intended to limit this application. Any modification, equivalent replacement, or improvement made within the spirit and principle of this application shall fall within the scope of this application.

What is claimed is:

1. A virtual character control method, performed by a computer device, comprising:
displaying a virtual environment picture of a virtual environment observed from an angle of view of a first virtual character;
displaying prompt information in response to a character state of the first virtual character meeting a preset condition, the prompt information indicating that the first virtual character has a capability of carrying another virtual character; and
canceling display of a second virtual character in response to the second virtual character being within a preset range of the first virtual character, a position of the second virtual character, whose display is canceled, changing along with a position of the first virtual character.

2. The method according to claim 1, wherein canceling display of the second virtual character includes:
canceling display of the second virtual character in response to the second virtual character moving into a shadow of the first virtual character.

3. The method according to claim 1, wherein canceling display of the second virtual character includes:
transmitting a collision event occurring between a collider deployed within the preset range and a collider of the second virtual character to a server in response to the collision event being detected; and
canceling display of the second virtual character in response to receiving a carrying notification from the server, the carrying notification being generated by the server in response to receiving a carrying request from a client corresponding to the second virtual character, and the carrying request requesting the first virtual character to carry the second virtual character.

4. The method according to claim 1, wherein:
a model of the second virtual character is hidden in a model of the first virtual character;
the model of the second virtual character is hidden in the shadow of the first virtual character; or
the model of the second virtual character is hidden in the prompt information.

5. The method according to claim 1, wherein the second virtual character, whose display is canceled, shares the angle of view with the first virtual character.

6. The method according to claim 1, wherein displaying the prompt information in response to the character state of the first virtual character meeting the preset condition includes:
in response to receiving an operation of controlling the first virtual character to use a virtual prop and the virtual prop meeting a trigger condition, obtaining a shadow area corresponding to a shadow of the first virtual character; and
displaying the prompt information on the shadow of the first virtual character in response to the shadow area being greater than or equal to a threshold.

7. The method according to claim 6,
wherein the shadow area is greater than or equal to the threshold;
the method further comprising:
skipping displaying the prompt information in response to the first virtual character being in at least one of a knocked-down state, a state of being in a virtual vehicle, a climbing state, a rescue state, or a state of a virtual health value being 0.

8. The method according to claim 1, further comprising, after canceling display of the second virtual character, redisplaying the second virtual character next to a position of the first virtual character in response to:
a remaining effective duration of a virtual prop used by the first virtual character being 0, the character state of the first virtual character meeting the preset condition including the first virtual character using the virtual prop;
a client corresponding to the second virtual character initiating a release request;
the first virtual character entering at least one of a state of a virtual health value being 0, a knocked-down state, or an injured state; or
the shadow of the first virtual character disappearing.

9. The method according to claim 1, further comprising:
obtaining a shadow area corresponding to the shadow of the first virtual character; and
determining a display duration of the prompt information according to the shadow area, the display duration being positively correlated with the shadow area.

10. The method according to claim 9, further comprising:
obtaining a ratio of a model area of the second virtual character to a model area of the first virtual character;
wherein determining the display duration includes determining the display duration according to the ratio and the shadow area, the display duration being positively correlated with the ratio and positively correlated with the shadow area.

11. The method according to claim 1, further comprising, after displaying the prompt information:
canceling display of the prompt information in response to the prompt information meeting a disappearance condition; and
maintaining display of a third virtual character in response to the third virtual character moving into the shadow of the first virtual character.

12. A non-transitory computer-readable storage medium storing a computer program stored that, when executed by a processor, causes a terminal device including the processor to implement the method according to claim 1.

13. A terminal device comprising:
a processor; and
a memory storing a computer program that, when executed by the processor, causes the terminal device to:
display a virtual environment picture of a virtual environment observed from an angle of view of a first virtual character;
display prompt information in response to a character state of the first virtual character meeting a preset condition, the prompt information indicating that the first virtual character has a capability of carrying another virtual character; and
cancel display of a second virtual character in response to the second virtual character being within a preset range of the first virtual character, a position of the second virtual character, whose display is canceled, changing along with a position of the first virtual character.

14. A virtual character control method, performed by a computer device, comprising:
displaying a virtual environment picture of a virtual environment; and
in response to prompt information, that indicates a first virtual character having a capability of carrying another virtual character, being displayed and a second virtual character moving into a preset range of the first virtual character, updating display of the virtual environment picture;
wherein:
the virtual environment picture is a picture of the virtual environment observed from an angle of view of the second virtual character; and
display of the second virtual character in the virtual environment is canceled and a position of the second virtual character in the virtual environment changes along with a position of the first virtual character.

15. The method according to claim 14, wherein updating display of the virtual environment picture includes:
switching the virtual environment picture to another virtual environment picture of the virtual environment that is observed from an angle of view of the first virtual character; and
updating display of the another virtual environment picture based on a change of the position of the first virtual character.

16. The method according to claim 14, wherein updating display of the virtual environment picture in response to the second virtual character moving into the preset range of the first virtual character includes:
displaying a control in response to the second virtual character moving into a shadow of the first virtual character;
transmitting a carrying request to a server in response to an operation of triggering the control, the carrying request requesting the first virtual character to carry the second virtual character; and
updating display of the virtual environment picture in response to receiving a carrying notification from the server.

17. The method according to claim 14, further comprising, after updating display of the virtual environment picture:
displaying a control;
transmitting a release request to a server in response to an operation of triggering the control, the release request requesting to release from the first virtual character; and
in response to receiving a release notification from the server, displaying the virtual environment picture of the virtual environment observed from the angle of view of the second virtual character, the second virtual character being redisplayed next to the position of the first virtual character.

18. A terminal device comprising:
a processor; and
a memory storing a computer program that, when executed by the processor, causes the terminal device to implement the method according to claim 14.

19. A non-transitory computer-readable storage medium storing a computer program stored that, when executed by a processor, causes a terminal device including the processor to implement the method according to claim 14.
